(19) United States
(12) Patent Application Publication
(10) Pub. No.: US 2012/0089519 A1
(43) Pub. Date: Apr. 12, 2012

(54) SYSTEM AND METHOD FOR SINGLE USE TRANSACTION SIGNATURES

(76) Inventor: Prasad Peddada, Alameda, CA (US)

(21) Appl. No.: 13/171,212

(22) Filed: Jun. 28, 2011

Related U.S. Application Data
(60) Provisional application No. 61/390,527, filed on Oct. 6, 2010.

(51) Int. Cl. H04L 9/32; G06Q 30/00

(52) U.S. Cl. 705/71; 713/170; 713/169

(57) ABSTRACT

A system and method for providing transaction-level security, such as authentication, authorization, or non-repudiation of business-related and other transactions, using shared keys and single use transaction signatures (SUTS). In accordance with an embodiment, to utilize the system, a user registers a client device with an identity service provider (IdP). The client device can be a computing device such as a mobile phone, personal digital assistant (PDA), netbook, or other specialized computer or computing device, each of which are hereinafter generally referred to as a “client device”. The registration process typically involves setting-up a shared secret key and personal identification number (pin). Once registered, all communication between the client device and the IdP is encrypted using a key generated with some combination of the secret key, pin, and/or timestamp, over a secured channel (e.g. https). For a particular transaction, users can generate digital transaction signatures using the client device, and third-party applications or parties can verify the transaction signature by providing a transaction identifier (id) and the signature to the IdP. In accordance with various embodiments, the transaction signature comprises encoding some combination of a transaction id, shared secret key (or manipulation thereof), secret pin, timestamp, and/or transaction type, which in accordance with some embodiments can be based on message authentication code (MAC). In accordance with an embodiment, a third-party, such as a bank, can validate a transaction themselves through a special arrangement with the IdP. In these scenarios, the bank can act as a delegated IdP between the user and a merchant, protecting the user and the merchant from malicious transactions.

### CLAIM OF PRIORITY

This application claims the benefit of priority to U.S. Provisional Patent Application Ser. No. 61/390,527, titled “SYSTEM AND METHOD FOR USE OF SINGLE USE TRANSACTION SIGNATURES TO PREVENT IDENTITY THEFT AND FRAUD”, filed Oct. 6, 2010, and herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

Embodiments of the invention are generally related to systems and methods for use in electronic, online, or other forms of commerce, and are particularly related to a system and method for providing transaction-level security, such as authentication, authorization, or non-repudiation of business-related and other transactions.

### BACKGROUND

In today's electronic commerce environments, emphasis is placed on authenticating a user using a username and password, or determining whether the user is indeed a human (such as the use of a “captcha” which displays a human-readable text that the user must enter to gain access). However, existing techniques fall short when protecting users against identity theft and fraud, since hackers can use a variety of techniques such as phishing, pharming, and man-in-the-middle attacks to commit fraud, and it is quite easy to, for example, steal passwords by phishing. Worldwide, this type of identify theft can amount to billions of dollars in lost revenue and other damage. These are the general areas that embodiments of the invention are intended to address.

### SUMMARY

Described herein is a system and method for providing transaction-level security, such as authentication, authorization, or non-repudiation of business-related and other transactions, using shared keys and single use transaction signatures (SUTS). In accordance with an embodiment, to utilize the system, a user registers a client device with an identity service provider (IdP). The client device can be a computing device such as a mobile phone, personal digital assistant (PDA), netbook, or other specialized computer or computing device, each of which are hereinafter generally referred to as a “client device”. The registration process typically includes setting-up a master shared secret key and a personal identification number (pin). The shared secret key can be, for example, a 512-bit random key that is unique for each account, but in other instances the shared secret key can be of other types or lengths. In accordance with some embodiments public key infrastructure (PKI) can be used, wherein the private key is stored on the client device, and the IdP is the authority for the public key. The pin can be, for example, a 4-digit number that is easily remembered by the user, but in other instances the pin can be anything the user chooses it to be. For added security, the pin should never be stored on the client device. Once registered, all communication between the client device and the IdP is encrypted using a key generated with some combination of the secret key, pin, and/or timestamp, over a secured channel (e.g. https).

As an alternative to the user themselves registering the client device, an already preconfigured client device can be provided to the user, eliminating the need for registration.

For a particular transaction, users can generate digital transaction signatures using the client device, and third-party applications or parties can verify the transaction signature by providing a transaction identifier (id) and the signature to the IdP.

In accordance with various embodiments, the transaction signature comprises encoding some combination of a transaction id, shared secret key (or manipulation thereof), secret pin, timestamp, and/or transaction type, which in accordance with some embodiments can be based on message authentication code (MAC). Depending on the implementation, the transaction signatures can be in multiple formats. For example, a signature in a short format can be a 6-10 digit number; while a signature in a long format can be a combination of alphanumeric and special characters. In accordance with various embodiments, the signature can also be represented, e.g. as a barcode or in another machine or computer-readable format, to make it possible to be automatically scanned using, e.g. a barcode or other reader, or as some other format compatible for communication with a device.

Not all transactions need a timestamp, but adding a timestamp can further enhance security.

In accordance with an embodiment, a third-party, such as a bank, can validate a transaction themselves through a special arrangement with the IdP. In these scenarios, the bank can act as a delegated IdP between the user and a merchant, protecting the user and the merchant from malicious transactions. In accordance with an embodiment, the system allows for verification, authentication, or authorization of transactions of the user and/or the client device without exchange of secrets with the service provider.

### BRIEF DESCRIPTION OF THE FIGURES

FIG. 1 shows an illustration of a system that enables the use of single use transaction signatures, in accordance with an embodiment.

FIG. 2 shows an illustration of the use of single use transaction signatures with an identity provider and various transactions and/or online applications, in accordance with an embodiment.

FIG. 3 shows a flowchart of a method for using single use transaction signatures, in accordance with an embodiment.

FIG. 4 shows an illustration of the use of a client device and/or application with a single use transaction signature system, in accordance with an embodiment.

FIG. 5 shows an illustration of the use of single use transaction signatures with a merchant, customer, or other third-party, in accordance with an embodiment.

FIG. 6 shows an illustration of the use of single use transaction signatures with an identity provider and a delegated identity provider, in accordance with an embodiment.

FIGS. 7-18 show illustrations of a client device, such as a mobile device and/or application interface for use with such a device, for use with single use transaction signatures, in accordance with an embodiment.

### DETAILED DESCRIPTION

As described above, a variety of techniques are currently used in online environments to determine, e.g. whether a user is authorized to access a particular resource, or whether a user is indeed a human person. Currently, there are no techniques to verify transactions. One-time-password (OTP) generators allow for authentication, but the existing technology is functionally incapable of supporting multiple accounts, or more than one website or application, or for anything other than authentication.

To address this, described herein is a system and method for providing transaction-level security, such as authentication, authorization, or non-repudiation of business-related and other transactions, using shared keys and single use transaction signatures (SUTS). In accordance with an embodiment, to utilize the system, a user registers a client device with an identity service provider (IdP). The client device can be a computing device such as a mobile phone, personal digital assistant (PDA), netbook, or other specialized computer or computing device, each of which are hereinafter generally referred to as a “client device”. The registration process typically includes setting-up a master shared secret key and a personal identification number (pin). The shared secret key can be, for example, a 512-bit random key that is unique for each account, but in other instances the key can be of other types or lengths. In accordance with some embodiments public key infrastructure (PKI) can be used, wherein the private key is stored on the client device, and the IdP is the authority for the public key. The pin can be, for example, a 4-digit number that is easily remembered by the user, but in other instances the pin can be anything the user chooses it to be. For added security, the pin should never be stored on the client device. Once registered, all communication between the client device and the IdP is encrypted using a key generated with some combination of the secret key, pin, and/or timestamp, over a secured channel (e.g. https).

As an alternative to the user themselves registering the client device, an already preconfigured client device can be provided to the user, eliminating the need for registration.

For a particular transaction, users can generate digital transaction signatures using the client device, and third-party applications or parties can verify the transaction signature by providing a transaction identifier (id) and the signature to the IdP.

In accordance with various embodiments, the transaction signature comprises encoding some combination of a transaction id, shared secret key (or manipulation thereof), secret pin, timestamp, and/or transaction type, which in accordance with some embodiments can be based on message authentication code (MAC). In accordance with some embodiments, the transaction id can include, for example, a number or value such as a dollar amount that is associated with a particular transaction. Depending on the implementation, the transaction signatures can be in multiple formats. For example, a signature in a short format can be a 6-10 digit number; while a signature in a long format can be a combination of alphanumeric and special characters. In accordance with various embodiments, the signature can also be represented, e.g. as a barcode or in another machine or computer-readable format, to make it possible to be automatically scanned using, e.g. a barcode or other reader, or as some other format compatible for communication with a device.

Not all transactions need a timestamp, but adding a timestamp can further enhance security.

In accordance with an embodiment, a third-party, such as a bank, can validate a transaction themselves through a special arrangement with the IdP. In these scenarios, the bank can act as a delegated IdP between the user and a merchant, protecting the user and the merchant from malicious transactions. In accordance with an embodiment, the system allows for verification, authentication, or authorization of transactions of the user and/or the client device without exchange of secrets with the service provider.

In accordance with an embodiment, for every account intended to be managed by the client device the system could set up a unique shared secret key and pin. Each account is capable of digitally signing different types of transaction (e.g. login/captcha transaction types, or verification/financial transaction types), and each transaction signature will be different based on the transaction type. This prevents someone from reusing the same signature for different purposes. In accordance with the embodiment, the transaction signature can be a cryptographically-signed hash using a combination of transaction identifier(s), shared secret, pin, timestamp and transaction type. Each signature can be verified by the third-party application with the IdP service for authenticity and non-repudiation. Since the third party in this service does not have access to the secret key and pin, the IdP acts as a mediator between the end user and the third-party to resolve disputes.

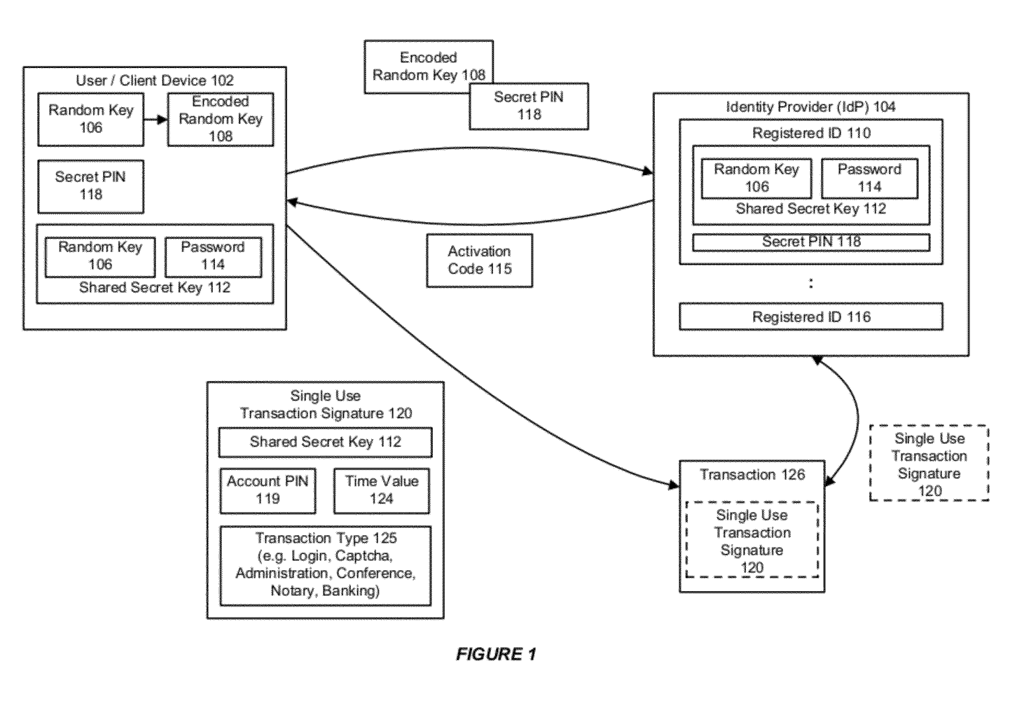

FIG. 1 shows an illustration of a system that enables the use of single use transaction signatures, in accordance with an embodiment. As shown in FIG. 1, a user initially registers a client device 102 with the IdP, and establishes an account using the device. The client device can be, for example, a mobile phone, personal digital assistant (PDA), netbook, or other computing device, alone and/or together with an application running on the device, which for the purposes of illustration are collectively referred herein as a client device. It will be evident that in accordance with various embodiments, the techniques described herein can be used with similar or other types of device, and with various subcategories of device, such as smart phones, Android, Blackberry, or iPhones. In accordance with some embodiments intended for a particular purpose, a special purpose or specialized client device can also be developed for use with that intended purpose. In accordance with various embodiments, the application can be installed or downloaded to such a client device, and executed thereon to provide the required functionality.

During the registration process, the user's client device 102 communicates with the IdP service 104, which in turn can be provided as a service running at another computer or server, and can be contacted via, e.g. a network, such as a telecommunications network or the Internet. It is also possible to preload client devices with shared secret keys, to make it easy for the end user.

Once the client device is registered with the IdP, all data exchanged between the IdP and the device will be encrypted using the shared secret key. This data encryption is optional if encryption is used at the communication protocol level such as, e.g. with transport layer security (TLS). TLS encryption reduces the need for encryption at the communication protocol level. However it is recommended to enable encryption at the data level as well as the communication protocol level for greater security.

In accordance with an embodiment, during a registration process, the client device can set up a shared secret key (e.g. of size 512-bit). The key length is not limited to 512-bits, and can be anything beyond 128-bit for greater security. During the registration process, the client device generates a random key 106 (e.g. a 256-bit key), which can be encoded (e.g. using base-64 encoding) to create an encoded random key 108. The user also selects a secret pin 118, such as a 4-digit number or a phrase, which will not be stored on the client device, but will instead be entered into the client device by the user when needed. The encoded random key and the secret pin are provided to the IdP service, where they are associated or registered 110 with the client device for this user.

The IdP service then optionally generates an activation code 115 (e.g. a 256-bit value), which is combined with the random key 106 to create a shared secret key 112 (e.g. a 512-bit value), and which shared secret key will be thereafter associated with this particular registered client device (and the corresponding user).

The activation code 115 is also communicated back to the client device, in some instances preferably over a different communication channel (such as SMS, regular postal/surface mail, or another protocol or communication means instead of http), wherein the client device then uses the activation code to duplicate the shared secret key 112 that is stored at the IdP service for this device. This completes the registration process for this particular user/client device.

The system is now ready to create accounts to be used to sign transactions for authentication and/or business transactions. In accordance with an embodiment, to create a new account, the device can repeat the same steps as device registration described above, or can generate a unique key (e.g. a 512 bit value) and a secret account pin 119 for each account, together with a timestamp, timestamp offset, or other time based value, and the account is registered with the IdP. The client device can use an encrypted communication channel when managing accounts such as creating new accounts, updating and disabling accounts.

Once the account is registered with the IdP, the device is ready to sign transactions on that account, using a combination, encoding, or other manipulation of the shared secret key stored on the client device, together with the user's secret pin as entered by the user, and optionally one or more of a transaction type, transaction identifier, timestamp, timestamp offset, or other time based value.

Additional accounts belonging to the same user, or different accounts belonging to different users of the same device, can also be registered 116 with the IdP service, using a similar process as described above.

When the user wishes to perform an authenticated or non-repudiatable transaction or use an authenticated or non-repudiatable application 126, such as with an online electronic commerce or banking application, which will use the IdP service, or a delegate IdP service to verify the authenticity of the transaction, the user uses the client device to generate a single use transaction signature (SUTS) 120.

In accordance with an embodiment, the transaction signature comprises the combination, encoding, or other manipulation of the shared secret key stored on the client device, together with the user's secret pin as entered by the user, and optionally one or more of a transaction type, transaction identifier, timestamp, timestamp offset, or other time based value, such as might be provided by a clock onboard the client device or an Internet clock. The user-selected secret pin is not stored on the client device but is instead entered into the client device by the user when needed. In accordance with other embodiments, the transaction signature can be created as a different combination of factors and in different formats.

The transaction or application receiving the transaction signature can contact the IdP service, to verify the authenticity of the signature. In accordance with an embodiment, if a timestamp is used to calculate the transaction signature, then the client device and the IdP service should be reasonably synchronized and/or the transaction signature will only be valid for a particular time period, which can vary depending on the particular implementation. Although the transaction signature can be automatically provided by the client device to the transaction or application, since the shared secret is known only to the user and the IdP, the process can be used to verify the authenticity of the user themselves.

In accordance with some embodiments, it is possible to delegate the IdP role to another service provider, such as a bank, or a credit card company. In this case, when the user registers for an account, instead of storing the shared secret for the account at the IdP, it is pushed to the delegated IdP. Functionally, the delegated IdP behaves exactly the same as the IdP. In this instance, the participants in typical transactions are a consumer, a bank/credit card company and a merchant. As a result of the higher security with digital signatures, this reduces the chances of fraud and loss to the merchant and the consumer.

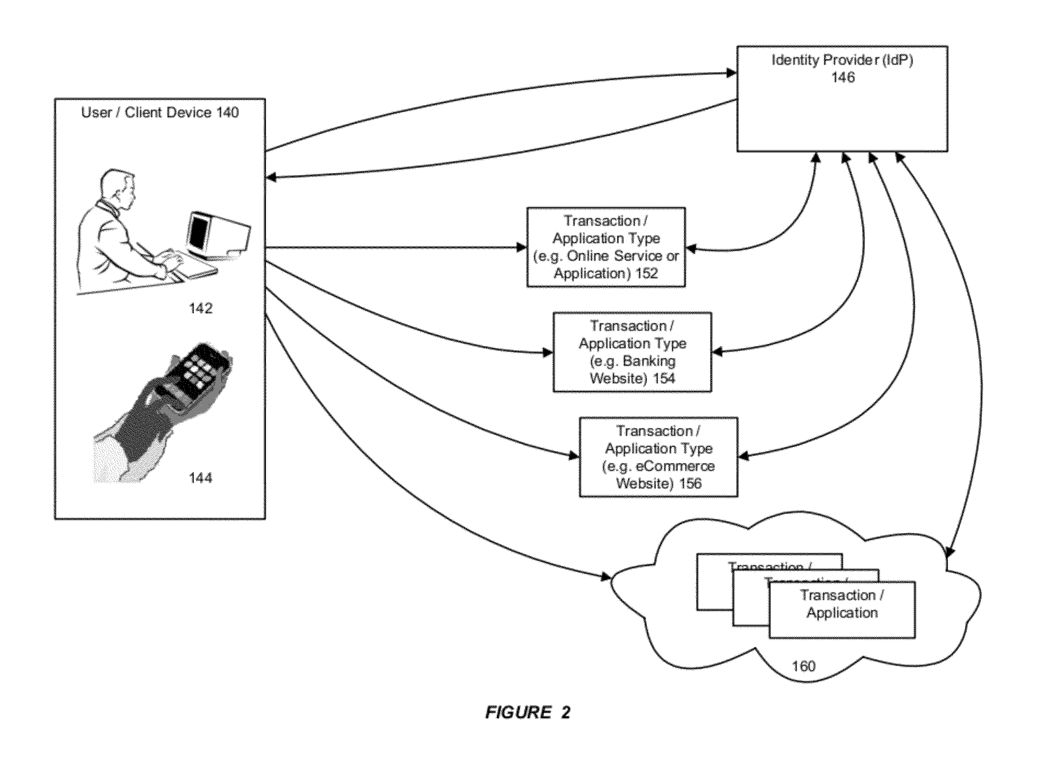

FIG. 2 shows an illustration of the use of single use transaction signatures with an identity provider and various transactions and/or online applications, in accordance with an embodiment. As shown in FIG. 2, the client device or application can be a personal computer 142, mobile telephone 144, or any other computing device with appropriate applications. When a registered user wishes to sign a transaction, such as an online ecommerce or banking application 152, 154, 156, or an application or service cloud 160, which uses the IdP service to validate the transaction, the user uses their client (e.g. mobile) device to generate a single use transaction signature, using the process described above, and provided that to the transaction or application. The transaction or application receiving the transaction signature can then either contact the IdP service 146, using for example a remote procedure call, redirect, or other technique, to verify the authenticity of the user for this transaction or application, or verify the transaction locally.

In accordance with various embodiments, each different type of transaction 152, 154, 156 can be associated with a transaction type parameter (e.g. login transaction, captcha transaction, signature transaction, commerce transaction, etc) and this transaction type parameter can be used as described above as a part of the combination, encoding, or other manipulation of the shared secret key, pin, transaction type, transaction identifier, timestamp, timestamp offset, or other time based value.

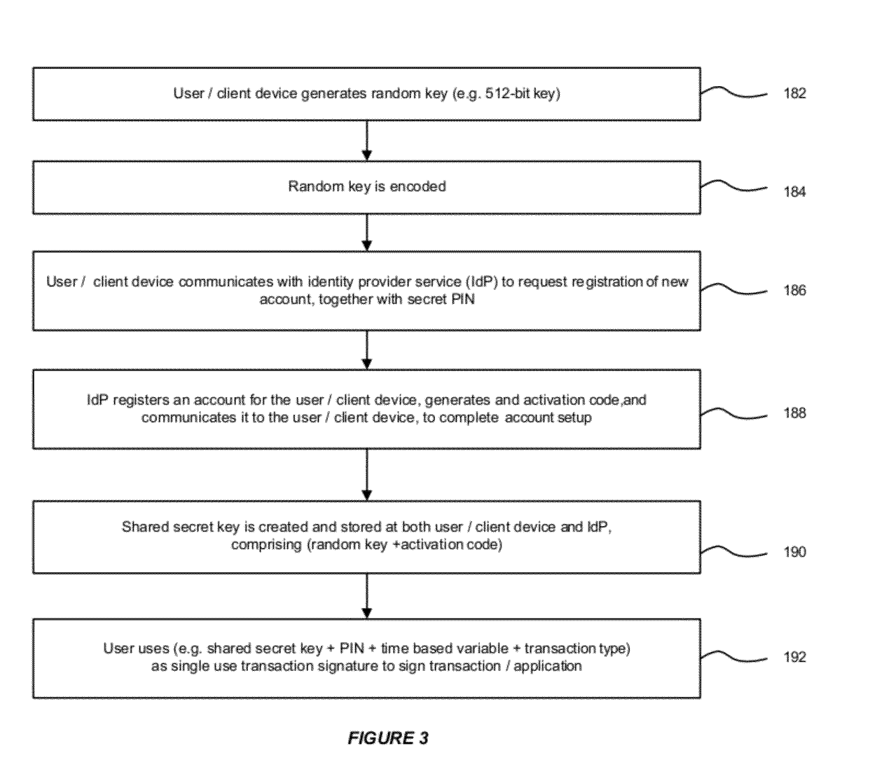

FIG. 3 shows a flowchart of a method for using single use transaction signatures, in accordance with an embodiment. As shown in FIG. 3, in step 182, a user/client device generates random key (e.g. a 256 bit key). In step 184, the random key is encoded (e.g. with a base-64 encoding scheme). In step 186, the user/client device communicates with the identity provider (IdP) system, server, or service to request registration of new device, together with a secret pin provided by the user. In step 188, the IdP system, server, or service registers an device for the user/client device, generates an activation code (e.g. a 256 bit encoded random key) and communicates it to the user/client device, to complete the device setup. In step 190, a shared secret key is created and stored at both the client device and the IdP system, server or service, comprising in one embodiment the random key (e.g. 256 bit key)+the activation code (e.g. 256 bit password) to make a 512 bit shared secret key. In step 192, the user can use the (shared secret key+pin+time based value) to generate a unique secrete key to encrypt all communications between the IdP and the client device.

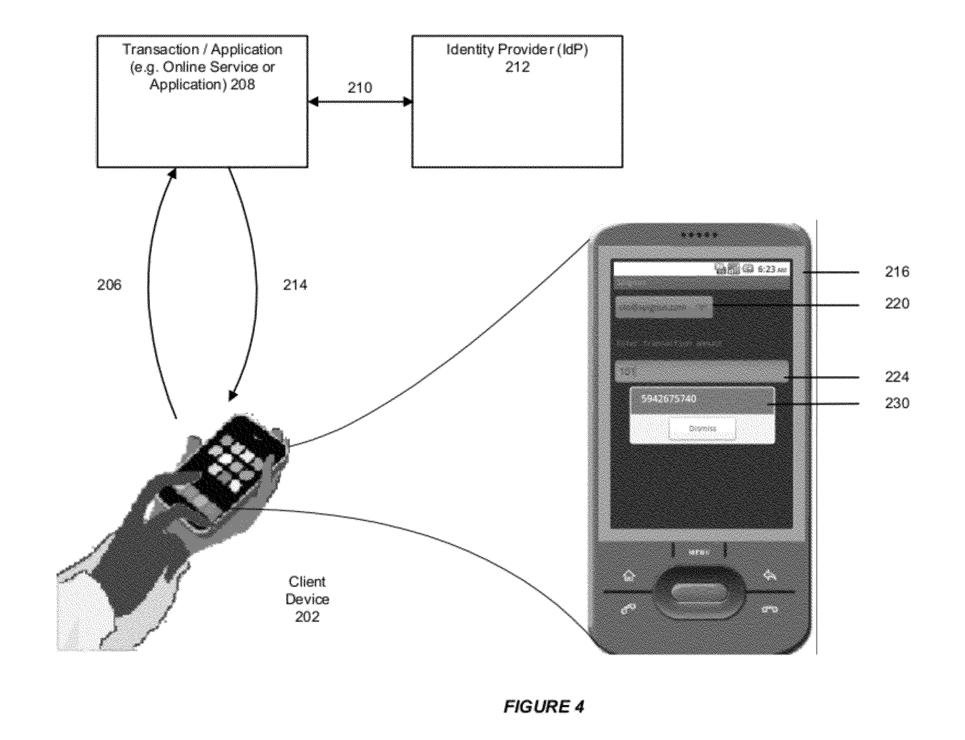

FIG. 4 shows an illustration of the use of a client device and/or application with a single use transaction signature system, in accordance with an embodiment. As shown in FIG. 4, in accordance with an embodiment, a user who wishes to utilize the system can use a client device 202, such as a mobile device, cellular telephone, PDA, or another computer or computing device, to access a transaction or application 208, such as a transaction or online service. Typically, the transaction or application can prompt 206 for information from the user, such as a username and/or password and/or other identifying information. In the context of, e.g. an ecommerce transaction, a particular transaction may provide transaction-particular information, such as an order checkout screen, with order details and final total amounts, and request the user confirm that the order should be placed. In accordance with an embodiment, the client (e.g. mobile) device includes an interface 216 that allows the user to identify themselves 220 (e.g. by use of a pull-down menu), and to enter their secret pin or information pertaining to the particular transaction (e.g. the order, such as the order or transaction total amount 224, or another transaction-related value). The user can then request that the application generate a transaction signature, which can be in either a short format or long format, or in another format such as an initial, or a machine or computer-readable format such as a barcode. The transaction signature can be generated as described above, and displayed 230 on the client device. This transaction signature is specific both to the user, and to the particular transaction for which it is generated and for the type of the transaction. The user can then provide 214 the transaction signature to the transaction or application, which can verify the authenticity of the transaction 210, using the IdP service 212, or by itself if the application is a delegated IdP.

It will be evident that in accordance with various embodiments, the techniques described herein can also be used with similar or other types of transaction or application, including the examples described below.

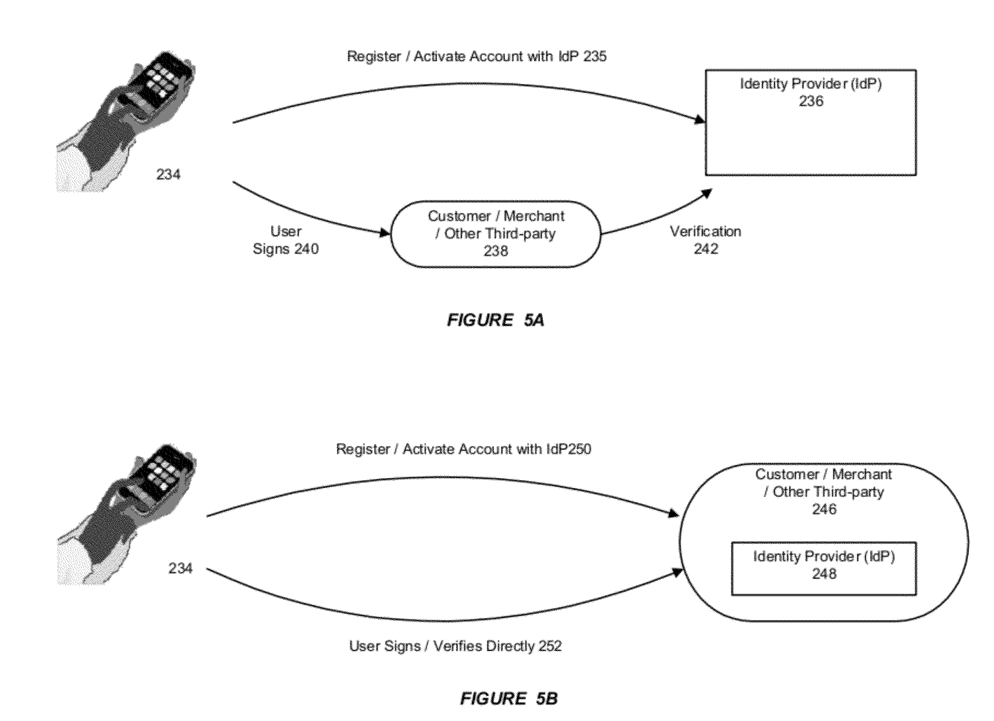

For example, FIG. 5 shows an illustration of the use of single use transaction signatures with a merchant, customer, or other third-party, in accordance with an embodiment. Depending on the particular implementation, the IdP service can be provided as a separate service, or alternately can be provided by a merchant, customer, or other third-party themselves. As shown in FIG. 5A, if the IdP 236 is provide as a separate service, then a user 234 can register/activate 235 a device or account with the IdP, using the registration process as described above. When the user wishes to initiate a transaction with a particular merchant, customer, or other third-party 238, they can sign 240 the transaction and provide the transaction signature to that merchant, customer, or other third-party, who then contacts the IdP service for verification 242.

As shown in FIG. 5B, if the IdP service 248 is instead provide by a third-party themselves 246, then the user 234 can register/activate a device or account with that merchant, customer, or other third-party that provides the IdP service directly 250, using the registration process as described above. When the user wishes to initiate a transaction with the particular merchant, customer, or other third-party, they can sign the transaction with that merchant, customer, or other third-party directly 252, who then uses their own IdP service for verification.

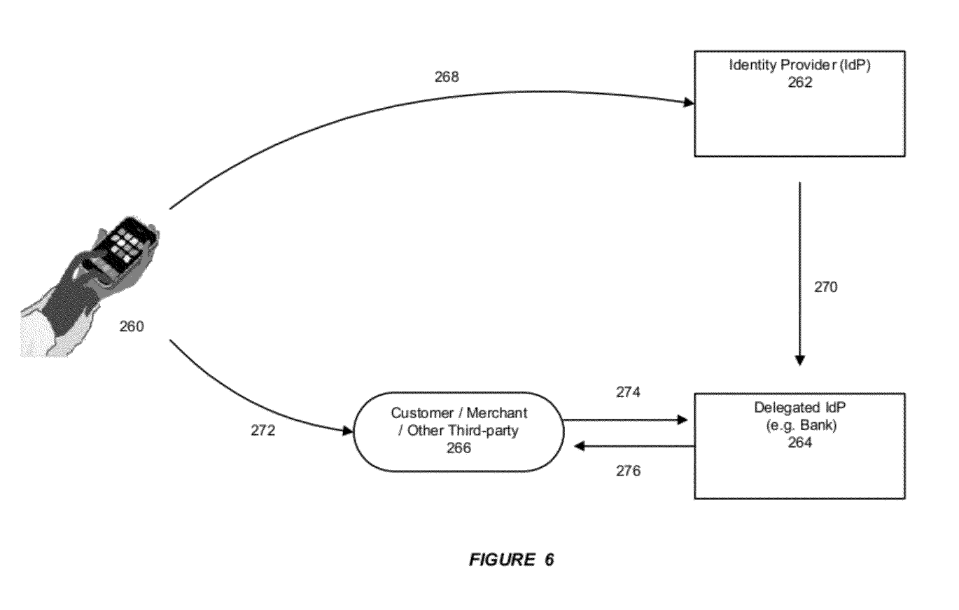

FIG. 6 shows an illustration of the use of single use transaction signatures with an identity provider and a delegated identity provider, in accordance with an embodiment. As shown in FIG. 6, an IdP Service 262 can delegate some or all of its IdP functionality to another agency, such as a bank, credit-card, or other institution 264. A user 260 can register/activate 268 a device or account with the IdP, using the registration process as described above. When the user wishes to initiate a transaction with a particular merchant, customer, or other third-party 266, they can sign the transaction with that merchant, customer, or other third-party directly 272, who then uses the delegated IdP service for verification, including forwarding the transaction information 274 to the delegated IdP service, and receiving verification 276 of the user's identity.

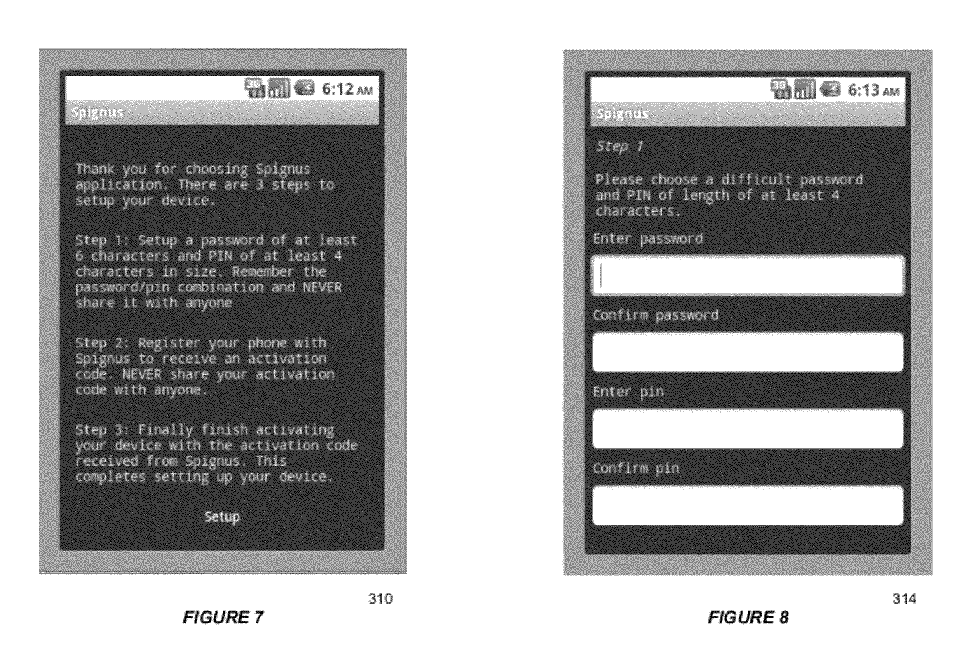

FIGS. 7-14 show illustrations of a client device, such as a mobile device and/or application interface for use with such a device, for use with single use transaction signatures, in accordance with an embodiment.

As shown in FIG. 7, in accordance with an embodiment, the client device interface 310 can present a splash screen or similar introductory screen, together with instructions to the user on how to setup the device, including setting up a password, registering the device (in this instance a phone) with an IdP, and activating the device with the activation code received from the IdP.

As shown in FIG. 8, in a first step, the user can be prompted 314 to choose and enter a password and a corresponding pin.

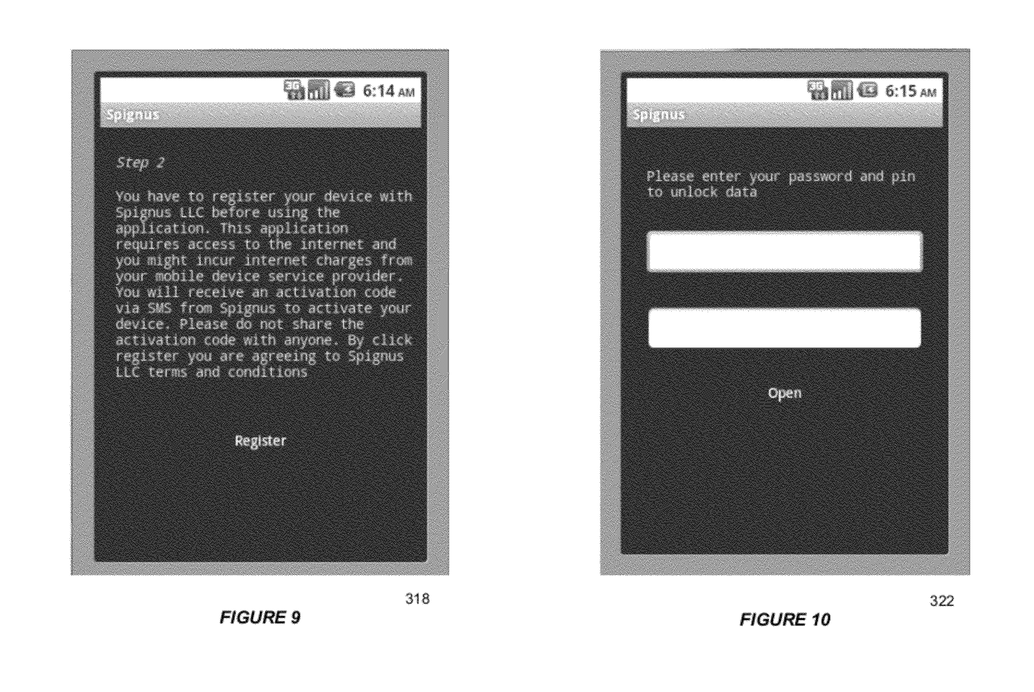

As shown in FIG. 9, in a second step, the user can be presented with additional information 318 prior to registration.

As shown in FIG. 10, the user can be prompted 322 to enter their password and pin into the device to unlock data.

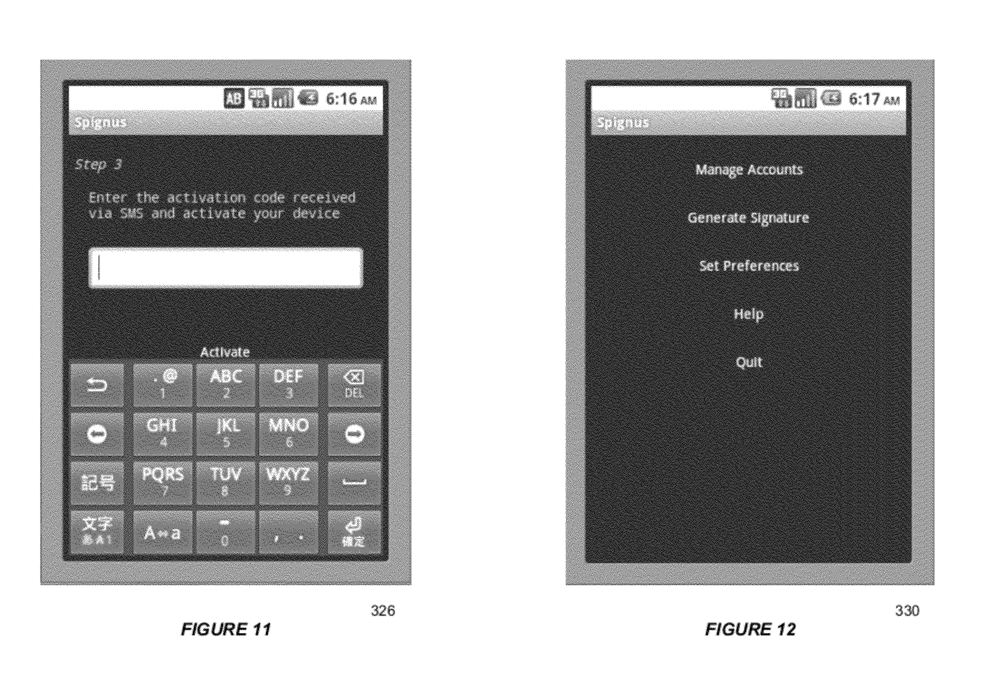

As shown in FIG. 11, in a third step, the user can be prompted 326 to enter the activation code they have received from the IdP (in some embodiments via a different protocol, such as in this instance via SMS) into the device, to activate the device.

As shown in FIG. 12, the device can then provide the user with a number of options 330, such as to manage their accounts, generate a signature, or set preferences.

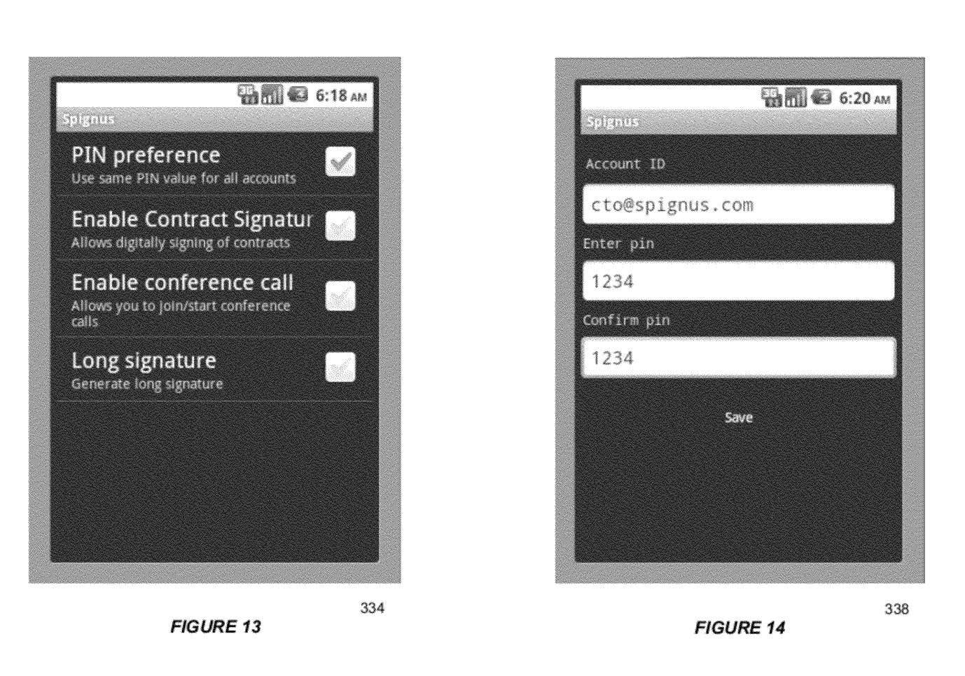

As shown in FIG. 13, depending on the different applications supported by the device (and accounts registered thereon), the user can be provided with a variety of different transaction-related options 334, for example enabling their pin preference, enabling conference calls, enabling contract signings, or generating a long signature. The options and transaction types shown in FIG. 13 are provided for purposes of illustration. Additional details about these and other forms of transaction type that can be supported with various embodiments are provided below.

As shown in FIG. 14, the device can then prompt the user 338 to enter an account identifier, together with a pin, and save the combination on their device.

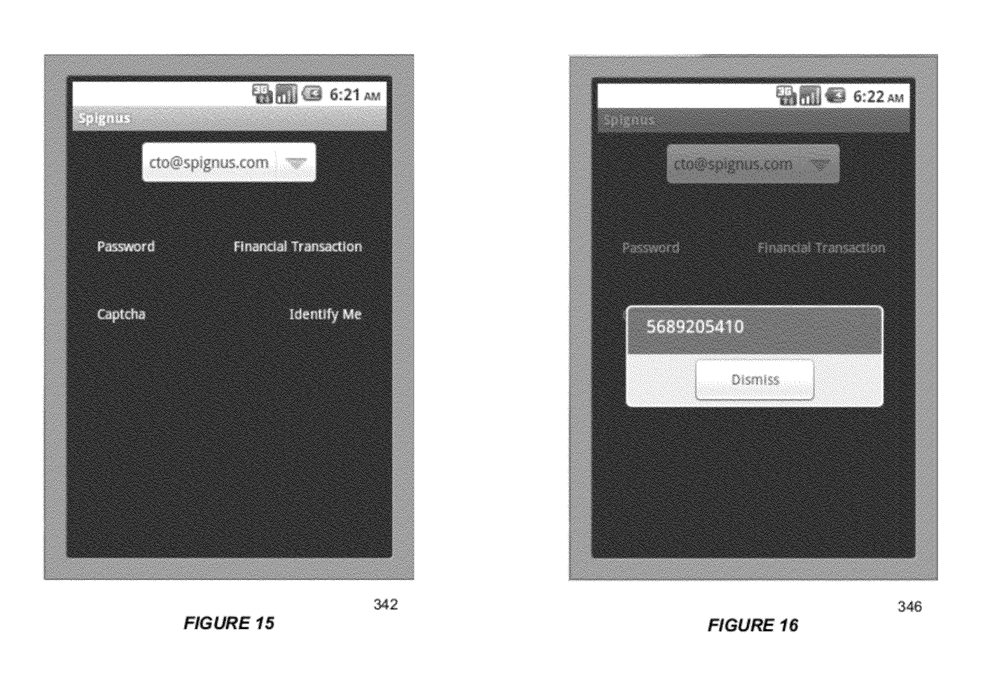

As shown in FIG. 15, the device can then provide the user with a number of different transaction types 342 that they can sign, such as to use the device to enter a password, perform a financial transaction, complete a captcha, or provide an “Identify Me” personal identification. Again, the transaction types shown in FIG. 15 are provided for purposes of illustration, and additional details about these and other forms of transaction type that can be supported with various embodiments are provided below.

As shown in FIG. 16, once the transaction type has been identified, and the signature requested, the device can display a signature for the transaction 346, which the user can enter into the transaction (e.g. into a contract, captcha page, login, conference call, online order, or other application) to authenticate their transaction.

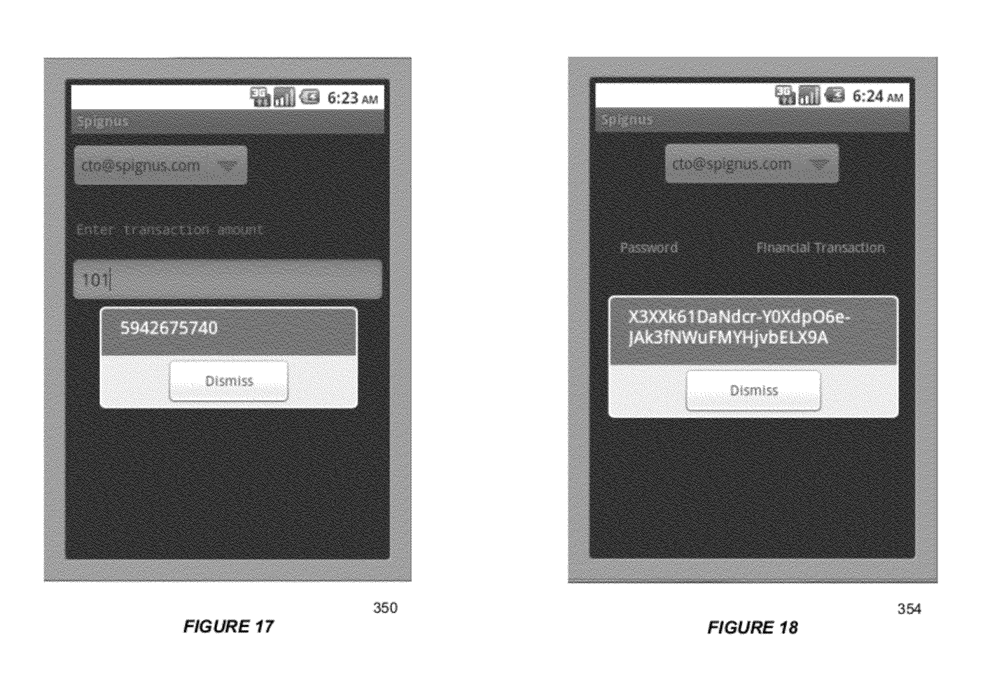

As shown in FIG. 17, in accordance with some embodiments, the transaction id can include, for example, a number or value such as a dollar amount that is associated with a particular transaction 350, in which instances the device uses this value as part of generating and displaying the signature for the transaction.

As shown in FIG. 18, depending on the application and/or the user-specifed options, the device can provide the user with a signature either in the short format described above in FIG. 16, or in a long format 354 which in some instances can be a combination of alphanumeric and special characters.

### Additional Uses

In accordance with various embodiments, the techniques described above can be used with similar or other types of transaction or application, or to provide other functionality, including, for example, a method for providing a user “captcha” feature; a method of simple authentication with an IdP service provider; a method of mutual authentication between two entities; a method for use in online and/or personal credit-card transactions; a method of providing notary-like functions; a method of providing authenticated communications, such as conference calls; a method of providing verified and/or non-repudiatable contract signings; and other transactions or applications as may be required. Some of these are described below by way of illustration, although it will be evident that the techniques described herein can be similarly used with other transactions or applications, and are not limited to those described herein.

### 1. User “Captcha” Feature

In accordance with an embodiment, the above-described techniques can be used to provide a method for providing a user “captcha” feature or transaction type. For example, in accordance with an embodiment, the method can include:

A user enters an identifying information, such as a username, email address, or other identifier.

The user selects a captcha transaction type.

The user uses the above techniques to generate a signature associated with his/her identifying information, and provides the signature to a third party service provider. Depending on the implementation the signature can provided as-is, or converted to a short or long format signature, an initial or other form of signature.

The third party service provider receives the signature (or initial), and uses it to identify that the user is a human rather than a computer program, before providing service to the user.

A given signature cannot be used more than once across different applications and the signature can only be used for identifying human, versus an automated programming creating accounts.

2. Simple Authentication with an Idp Service Provider

In accordance with an embodiment, the above-described techniques can be used to provide a method for providing a method of simple authentication with an IdP service provider. For example, in accordance with an embodiment, the method can include:

A user enters an identifying information, such as a username, email address, or other identifier.

The user uses the above techniques to generate a transaction signature associated with his/her identifying information, and provides the signature to a third-party service provider.

The third-party service provider receives the signature, and uses it as part of a remote procedure call (RPC), or a redirect, to an identity service provider, to verify the identity of the user for a particular application, or directly if it is the delegated service provided for the purpose of authenticating the user.

3. Mutual Authentication Between Two Entities

In accordance with an embodiment, the above-described techniques can be used to provide a method for providing a method of mutual authentication between two entities. For example, in accordance with an embodiment, the method can include:

A user enters an identifying information, such as a username, email address, or other identifier into a client browser.

The user generates a random token, and provides the random token to a remote server and challenges the remote server to produce a signature for the random token.

The remote server signs the random token provided by the user, and returns it to the user.

The user validates the server-generated signature for the random token.

The remote server similarly generates a random token, and challenges the user to produce a signature for its random token.

When both tokens are validated, the user and remote server are considered authenticated with one another.

No secrets are exchanged, only the random tokens and signatures.

4. Online and/or Personal Credit-Card Transactions

In today's commerce environments, a credit card alone is not sufficient anymore to ensure the identity or authenticity of a user. In accordance with an embodiment, the above-described techniques can be used to provide a method for providing a method for use in online and/or in-person credit-card transactions, for improved security. For example, in accordance with an embodiment, the method can include:

A user first sets up a shared secret between the user and either an identity provider service, or a financial entity, using the above techniques.

For online credit-card transactions, such as using a web form, a user first sets up a shared secret between the user and either an identity provider service, or a financial entity acting as delegated IdP, using the above techniques.

During a particular transaction, the user uses the above techniques to generate a transaction signature for the particular transaction, e.g. by signing a vendor id and/or a transaction amount or other information, and inputs the resultant signature value into the web form.

The transaction authenticity is verified using the above techniques, and unless the signature is present and validated, the transaction is either not approved, and/or is rejected.

During a particular transaction, the user uses the above techniques to generate a transaction signature associated with the particular transaction, e.g. by signing a vendor id and/or a transaction amount or other information, and provides the resultant signature value to the store clerk.

The store clerk enters the signature value to their system, instead of a traditional handwritten or pin-based confirmation; the transaction authenticity is verified using the above techniques, and unless the signature is present and validated, the transaction is either not approved, and/or is rejected. In accordance with some embodiments, the system can be configured e.g., to require the full format signature, rather than the shorter format, on larger transactions.

In accordance with some embodiments, the signature can be generated as a barcode or other machine or computer-readable format, which can be easily scanned by the store clerk, or as some other format compatible for communication with a device.

### 5. Online Bank Transactions

In accordance with an embodiment, the above-described techniques can be used to provide a method for providing a method for use in online bank transactions. For example, in accordance with an embodiment, the method can include:

For bank transactions, such as using a web form, a user first sets up a shared secret between the user and either an identity provider service, or a financial entity acting as delegated IdP, using the above techniques.

During a particular transaction, the user uses the above techniques to generate a transaction signature associated with the particular transaction, e.g. by signing a vendor id and/or transaction type (e.g. setting up new account, transferring money) and/or a transaction amount or other information, and inputs the resultant signature value into the web form.

The transaction signature is verified using the above techniques, and unless the signature is present and validated, the transaction is either not approved, and/or is rejected. This adds an extra layer of security on top of existing protections that the bank has. In essence the user is signing transaction and needs explicit approval and verification. To reduce the burden this could be applied to those transactions relating to larger than a certain monetary amount.

### 6. Notary-Like Functions

In accordance with an embodiment, the above-described techniques can be used to provide a method for providing a method of providing notary-like functions, or a notarized transaction. For example, in accordance with an embodiment, the method can include:

A notary records the typical user identification information required as part of any particular notarization.

The notary uses their client device and the above techniques to generate a transaction signature associated with this particular notarization, and stores it securely.

The stored signature can be retrieved and verified at a later time to confirm the authenticity of the notarization.

### 7. Authenticated Communications

In accordance with an embodiment, the above-described techniques can be used to provide a method for providing a method of providing authenticated communications, such as conference call transactions. For example, in accordance with an embodiment, the method can include:

A user, such as a meeting organizer, sets up a meeting with a meeting identifier such as a telephone conference.

Each participant registers for the meeting, by entering identifying information, such as a username, email address, or other identifier, and/or upon accepting a meeting invitation their individual telephone number is automatically added to the organizer's system call list.

System prompts each participant to enter their signature, or user e.g., clicks to join a conference call.

The system uses the above techniques to verify the authenticity of each participant and allow them access the meeting (e.g. the telephone conference).

Phone makes remote procedure call with the transaction signature, and the user receives a callback and the system then places the user into the conference call. The user can optionally provide a callback number.

8. Verified and/or Non-Repudiatable Contract Signings

In accordance with an embodiment, the above-described techniques can be used to provide a method for providing a method of providing verified and/or non-repudiatable contract signings. For example, in accordance with an embodiment, the method can include:

Parties to a digital contract first set up shared secrets between those users and either an identity provider service, or a delegated entity, using the above techniques.

During contract signing, each user uses the above techniques to generate a transaction signature associated with the contract, which are thereafter stored securely and associated with the contract.

The user's signature can be verified using the above techniques, and unless the signature is present and validated, the contract can be either not approved, and/or rejected; and/or the stored signatures can be retrieved and verified at a later time to confirm the authenticity of the parties transaction.

Contract can be generalized as a web form.

The contract can be any other form of agreement, such as agreeing to an action, or accepting a particular set of terms or conditions.

9. Secure Communication with Symmetric Keys

In accordance with an embodiment, the above-described techniques can be used to provide a method for providing a method of providing secure communication between a client and server:

Traditional HTTPS techniques do a handshake after authenticating the certificate provided by the server and then a shared secret is setup. Once the shared secret is setup further communication is encrypted using the shared secret setup dynamically.

Instead of using certificates and setting up shared secret, we propose to encrypt all communication using the signature generated specifically for communication with the server.

As the server knows the identity of the user and can generate the same shared key it is authenticating the user and securing the communication with the user.

If an imposter is acting as server, since the imposter doesn't have secret key he will not be able to decrypt the message sent by the user, tackling man in the middle attacks.

### 10. Building Access Control

In accordance with an embodiment, the above-described techniques can be used to provide for access control, such as at a building entrance. For example, a user can setup a shared secret for each building. Before the user attempts entry, they can use their client device to sign and produce a signature and then enter it at a keypad or other form of building entry device. In accordance with some embodiments, the device can produce a barcode or other machine or computer-readable output to be scanned to allow entry. The system can also log the time when entry happens for security-tracking purposes. This can reduce risks for companies, since, e.g. they don't have to give customer support representatives access to customer data.

### 11. Alternative ID System

In accordance an embodiment, the above-described techniques can be used to provide a form of user personal identification, in which, for example the “Identify Me” personal identification described above can be used as a replacement for e.g. the user's social security number or other personal information that the user might prefer to keep confidential.

### 12. Additional/Optional Features

In accordance with various other embodiments, the above-described systems and techniques can be used to provide additional features and functionality, including, but not limited to, for example:

In accordance with an embodiment, the system can be configured so that a signature can be restricted for use with a given transaction and/or a given purpose, and cannot be used for another purposes, e.g. if the transaction signature is configure for use as a login it cannot be used for a captcha.

In accordance with an embodiment, the technique can be used in combination with a single device that is capable of supporting an unlimited number of accounts and types of transaction.

In accordance with an embodiment, the system can be configured to take pictures (of e.g., the user), sign, and then transmit the pictures with the appropriate signature.

In accordance with an embodiment, the IdP is configured to lock accounts when hacking attempts are detected.

In accordance with an embodiment, crypto engines and Koolspan can be used as a extension of, or embedded, for added security.

In accordance with an embodiment, the technique can be used in combination with secure storage device, such as Koolspan-enabled devices.

In accordance with an embodiment, the system automatically retires keys upon reported theft of the device.

In accordance with an embodiment, a barcode or other machine or computer-readable signature is used.

In accordance with an embodiment, human notaries or similar functionality can be called upon to help migrate keys from a first device to a second device, to ensure the authenticity of the user remains valid.

In accordance with an embodiment, additional communications can be used between the IdP and its delegated IdP(s) to help detect and counteract fraud.

Push state encrypting, e.g. the state of user or other data at the device can be pushed to a server, and a key provided to the user for later retrieval.

Appendix A provides an example of a particular implementation of a system and method in accordance with an embodiment, which is provided for the purposes of illustration. It is not intended to be exhaustive or to limit the invention to the precise forms disclosed.

The present invention may be conveniently implemented using one or more conventional general purpose or specialized digital computers or microprocessors programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

### Appendix A

Appendix A provides an example of a particular implementation of a system and method in accordance with an embodiment, which is provided for the purposes of illustration. It is not intended to be exhaustive or to limit the invention to the precise forms disclosed.

main.xml is the main layout page, in accordance with an embodiment:

```
<?xml version=“1.0” encoding=“utf-8” ?>
- <LinearLayout
xmlns:android=“http://schemas.android.com/apk/res/android”
android:orientation=“vertical” android:layout_width=“fill_parent”
android:layout_height=“fill_parent”>
  <TextView android:typeface=“monospace”
android:layout_marginTop=“25dip” android:padding=“10dip”
android:layout_gravity=“center” android:layout_width=“wrap_content”
android:layout_height=“wrap_content”
android:text=“@string/welcome” />
  <TextView android:typeface=“monospace”
android:layout_marginTop=“2dip” android:padding=“10dip”
android:layout_gravity=“center” android:layout_width=“wrap_content”
android:layout_height=“wrap_content”
android:text=“@string/step1Desc” />
  <TextView android:typeface=“monospace”
android:layout_marginTop=“2dip” android:padding=“10dip”
android:layout_gravity=“center” android:layout_width=“wrap_content”
android:layout_height=“wrap_content”
android:text=“@string/step2Desc” />
  <TextView android:typeface=“monospace”
android:layout_marginTop=“2dip” android:padding=“10dip”
android:layout_gravity=“center” android:layout_width=“wrap_content”
android:layout_height=“wrap_content”
android:text=“@string/step3Desc” />
  <Button android:text=“@string/setupBtn”
android:id=“@+id/SetupButton” android:layout_marginTop=“12dip”
android:layout_width=“wrap_content”
android:layout_height=“wrap_content”
android:background=“#AA000000” android:textColor=“#ffffffff”
android:layout_gravity=“center_horizontal|bottom” />
  </LinearLayout>
```

actions.xml is for display various operations that the user can perform, in accordance with an embodiment:

```
<?xml version=“1.0” encoding=“utf-8” ?>
- <ScrollView android:layout_width=“fill_parent”
xmlns:android=“http://schemas.android.com/apk/res/android”
android:layout_height=“wrap_content”
android:id=“@+id/ActionsActivity”>
- <RelativeLayout android:layout_width=“fill_parent”
android:layout_height=“wrap_content”>
  <Button android:text=“@string/setupAccountBtn”
android:id=“@+id/addAccountBtn” android:layout_width=“fill_parent”
android:layout_marginTop=“25dip”
android:layout_height=“wrap_content”
android:background=“#AA000000”
android:textColor=“#ffffffff” />
  <Button android:text=“@string/generateSignatureBtn”
android:id=“@+id/genSignatureBtn” android:layout_width=“fill_parent”
android:layout_centerInParent=“true”
android:layout_marginTop=“30dip”
android:layout_height=“wrap_content”
android:background=“#AA000000”
android:textColor=“#ffffffff”
android:layout_below=“@id/addAccountBtn” />
  <Button android:text=“@string/settingBtn”
android:id=“@+id/settingsBtn”
android:layout_width=“fill_parent”
android:layout_marginTop=“30dip”
android:layout_height=“wrap_content”
android:background=“#AA000000”
android:textColor=“#ffffffff”
android:layout_below=“@id/genSignatureBtn” />
  <Button android:text=“@string/helpBtn” android:id=“@+id/helpBtn”
android:layout_width=“fill_parent” android:layout_marginTop=“30dip”
android:layout_height=“wrap_content”
android:background=“#AA000000”
android:textColor=“#ffffffff” android:layout_below=“@id/settingsBtn” />
  <Button android:text=“@string/quitBtn” android:id=“@+id/quitBtn”
android:layout_width=“fill_parent” android:layout_marginTop=“30dip”
android:layout_height=“wrap_content”
android:background=“#AA000000”
android:textColor=“#ffffffff” android:layout_below=“@id/helpBtn” />
  </RelativeLayout>
  </ScrollView>
```

financialsignature.xml defines a layout for financial transaction signature generation, in accordance with an embodiment:

```
<?xml version=“1.0” encoding=“utf-8” ?>
- <ScrollView android:layout_width=“fill_parent”
xmlns:android=“http://schemas.android.com/apk/res/android”
android:layout_height=“wrap_content”
android:id=“@+id/FinancialSignatureActivity”>
- <RelativeLayout android:layout_width=“fill_parent”
android:layout_height=“wrap_content”>
  <Spinner android:id=“@+id/lmSpinner”
android:layout_width=“wrap_content”
android:typeface=“monospace” android:layout_height=“wrap_content”
android:drawSelectorOnTop=“true” android:layout_marginTop=“10px”
android:prompt=“@string/accountId” />
  <TextView android:text=“@string/transactionAmt”
android:id=“@+id/transactionAmtTV”
android:layout_marginTop=“25dip”
android:padding=“5dip” android:typeface=“monospace”
android:layout_width=“fill_parent”
android:layout_height=“wrap_content”
android:layout_below=“@id/lmSpinner” />
  <EditText android:id=“@+id/transactionAmtET”
android:layout_marginTop=“15dip” android:layout_width=“fill_parent”
android:layout_height=“wrap_content” android:textStyle=“normal”
android:typeface=“normal”
android:layout_below=“@id/transactionAmtTV” />
  <Button android:text=“@string/financialTxnBtn”
android:layout_marginTop=“40dip” android:id=“@+id/financialTxnBtn”
android:layout_width=“wrap_content”
android:layout_height=“wrap_content”
android:background=“#AA000000”
android:layout_below=“@id/transactionAmtET”
android:layout_centerInParent=“true” android:textColor=“#ffffffff” />
  </RelativeLayout>
  </ScrollView>
```

signatures.xml is a page that is used by SignaturesActivity class, in accordance with an embodiment:

```
<?xml version=“1.0” encoding=“utf-8” ?>
- <ScrollView android:layout_width=“fill_parent”
xmlns:android=“http://schemas.android.com/apk/res/android”
android:layout_height=“wrap_content”
android:id=“@+id/SignatureActivity”>
- <RelativeLayout android:layout_width=“fill_parent”
android:layout_height=“wrap_content”>
  <Spinner android:id=“@+id/lmSpinner”
android:layout_width=“wrap_content”
android:typeface=“monospace” android:layout_height=“wrap_content”
android:layout_centerHorizontal=“true”
android:drawSelectorOnTop=“true”
android:layout_marginTop=“10px”
android:prompt=“@string/accountId” />
- <TableLayout android:id=“@+id/table1”
android:layout_width=“fill_parent”
android:layout_marginTop=“50dip” android:stretchColumns=“1”
android:layout_height=“fill_parent”
android:layout_below=“@id/lmSpinner”>
- <TableRow>
  <Button android:text=“@string/websiteLoginBtn”
android:id=“@+id/websiteLoginBtn” android:gravity=“left”
android:layout_marginLeft=“25dip” android:background=“#AA000000”
android:textColor=“#ffffffff” android:layout_below=“@id/lmSpinner” />
  <Button android:text=“@string/financialTxnBtn”
android:id=“@+id/financialTxnBtn” android:gravity=“right”
android:background=“#AA000000” android:textColor=“#ffffffff”
android:layout_marginRight=“25dip” />
  </TableRow>
  </TableLayout>
- <TableLayout android:id=“@+id/table2”
android:layout_width=“fill_parent”
android:layout_marginTop=“50dip” android:stretchColumns=“1”
android:layout_height=“fill_parent”
android:layout_below=“@id/table1”>
- <TableRow>
  <Button android:text=“@string/captchaBtn”
android:id=“@+id/captchaBtn”
android:gravity=“left” android:layout_marginLeft=“25dip”
android:background=“#AA000000” android:textColor=“#ffffffff”
android:layout_below=“@id/lmSpinner” />
  <Button android:text=“@string/identifyMeBtn”
android:id=“@+id/identifyMeBtn” android:gravity=“right”
android:background=“#AA000000” android:textColor=“#ffffffff”
android:layout_marginRight=“25dip” />
  </TableRow>
  </TableLayout>
- <TableLayout android:id=“@+id/table3”
android:layout_width=“fill_parent”
android:layout_marginTop=“50dip” android:stretchColumns=“1”
android:layout_height=“fill_parent”
android:layout_below=“@id/table2”>
- <TableRow>
  <Button android:text=“@string/conferenceCallBtn”
android:id=“@+id/conferenceCallBtn” android:gravity=“left”
android:layout_marginLeft=“25dip” android:background=“#AA000000”
android:textColor=“#ffffffff” android:layout_below=“@id/lmSpinner” />
  <Button android:text=“@string/contractSignatureBtn”
android:id=“@+id/contractSignatureBtn” android:gravity=“right”
android:background=“#AA000000” android:textColor=“#ffffffff”
android:layout_marginRight=“25dip” />
  </TableRow>
  </TableLayout>
  </RelativeLayout>
  </ScrollView>
```

FinancialSigatureActivty is a class is for signing financial transactions, in accordance with an embodiment:

```
package com.spignus.activities;
import android.app.AlertDialog;
import android.content.DialogInterface;
import android.os.Bundle;
import android.view.View;
import android.widget.Spinner;
import com.spignus.constants.TransactionTypeEnum;
import com.spignus.security.SecurityHelper;
import com.spignus.security.SecurityWrapper;
/**
*
* @author Prasad Prasad
* (c) All Rights Reserved 2010
*
*/
public final class FinancialSignatureActivity extends SignaturesActivity {
  public void onCreate(Bundle bundle) {
    super.onCreate(bundle, R.id.financialTxnBtn,
R.layout.financialsignature);
    listAccounts( );
  }
  private void generateSignature(String accountName, String value) {
    SecurityHelper helper = SecurityWrapper.unwrap( );
    AlertDialog.Builder alertbox = new AlertDialog.Builder(this);
    alertbox.setMessage(helper.sign(accountName, value,
        !isEnabled(PreferencesActivity.SIGNATURE_PREF, false),
TransactionTypeEnum.FINANCIAL));
    alertbox.setNeutralButton(R.string.dismissDialogBtn,
        new DialogInterface.OnClickListener( ) {
          public void onClick(DialogInterface d, int id) {
            d.dismiss( );
            finish( );
            refreshAndRegister( );
          }
        });
    alertbox.show( );
  }
  public void onClick(View v) {
    String txnAmount = getTextAsString(R.id.transactionAmtET);
    Spinner spinner = (Spinner) findViewById(R.id.lmSpinner);
    String accountName = (String) spinner.getSelectedItem( );
    generateSignature(accountName, txnAmount);
  }
}
```

PreferencesActivity is a classfor setting preferences, in accordance with an embodiment:

```
package com.spignus.activities;
import android.content.Context;
import android.content.SharedPreferences;
import android.os.Bundle;
import android.preference.CheckBoxPreference;
import android.preference.Preference;
import android.preference.Preference.OnPreferenceClickListener;
import android.preference.PreferenceActivity;
import android.util.Log;
/**
*
* @author Prasad Prasad
* (c) All Rights Reserved 2010
*
*/
public class PreferencesActivity extends PreferenceActivity
implements
OnPreferenceClickListener {
  static final String PREF_FILE_NAME = “.spigprefs”;
  static final String PIN_PREF = “pinPref”;
  static final String CONF_CALL_PREF = “confCallPref”;
  static final String CONTRACT_PREF = “contractPref”;
  static final String SIGNATURE_PREF = “signaturePref”;
  @Override
  public void onCreate(Bundle bundle) {
    super.onCreate(bundle);
    addPreferencesFromResource(R.xml.preferences);
    registerPreference(PIN_PREF);
    registerPreference(CONF_CALL_PREF);
    registerPreference(CONTRACT_PREF);
    registerPreference(SIGNATURE_PREF);
  }
  public boolean onPreferenceClick(Preference preference) {
    CheckBoxPreference pref = (CheckBoxPreference) preference;
    String key = preference.getKey( );
    Log.v(“SAI”, key + “ ” + pref.isChecked( ));
    SharedPreferences prefs =
getSharedPreferences(PREF_FILE_NAME,
Context.MODE_PRIVATE);
    SharedPreferences.Editor editor = prefs.edit( );
    if (CONF_CALL_PREF.equals(key)) {
      editor.putBoolean(CONF_CALL_PREF, pref.isChecked( ));
    } else if (PIN_PREF.equals(key)) {
      editor.putBoolean(PIN_PREF, pref.isChecked( ));
    } else if (CONTRACT_PREF.equals(key)) {
      editor.putBoolean(CONTRACT_PREF, pref.isChecked( ));
    } else if (SIGNATURE_PREF.equals(key)) {
      editor.putBoolean(SIGNATURE_PREF, pref.isChecked( ));
    }
    return editor.commit( );
  }
  private void registerPreference(String key) {
    Preference pref = findPreference(key);
    pref.setOnPreferenceClickListener(this);
  }
}
```

SecurityHelper is a class for save encrypted file on the phone and for signing transactions, in accordance with an embodiment:

```
package com.spignus.security;
import java.io.FileOutputStream;
import java.io.IOException;
import java.nio.ByteBuffer;
import java.security.InvalidKeyException;
import java.security.NoSuchAlgorithmException;
import java.security.Provider;
import java.security.Provider.Service;
import java.security.Security;
import java.security.spec.InvalidKeySpecException;
import java.util.Calendar;
import java.util.List;
import javax.crypto.Cipher;
import javax.crypto.CipherInputStream;
import javax.crypto.CipherOutputStream;
import javax.crypto.Mac;
import javax.crypto.NoSuchPaddingException;
import javax.crypto.SecretKey;
import javax.crypto.SecretKeyFactory;
import javax.crypto.spec.PBEKeySpec;
import javax.crypto.spec.SecretKeySpec;
import android.content.Context;
import android.util.Log;
import com.spignus.constants.KeyParametersEnum;
import com.spignus.constants.LogTypesEnum;
import com.spignus.constants.TransactionTypeEnum;
import com.spignus.helpers.AppHelper;
import com.spignus.helpers.Base64;
import com.spignus.storage.DeviceStorageHelper.Account;
import com.spignus.storage.DeviceStorageHelper.Store;
/**
*
* @author Prasad Prasad
* (c) All Rights Reserved 2010
*
*/
public final class SecurityHelper {
  private static final String ALGORITHM = “PBEWITHSHA256AND256BITAES-CBC-BC”;
  private static final Provider PROVIDER = Security.getProvider(“BC”);
  private static final int ITER = 1024;
  private static final KeyParametersEnum DEFAULT =
KeyParametersEnum.TWO_FIFTY_SIX;
  private static final int INTERVAL = 30000;
  private static final int TOKEN_SIZE = 10;
  private static final int DIGITS_POWER = 1000000000;
  private final SecretKey key;
  private Store store;
  private final Context ctx;
  private final String salt;
  private SecurityHelper(char[ ] password, String salt, Context ctx) {
    this.key = generateKey(password, salt.getBytes( ));
    this.store = getStore(ctx);
    this.ctx = ctx;
    this.salt = salt;
  }
  public static SecurityHelper getSecurityHelper(char[ ] password, String
salt, Context ctx) {
    SecurityHelper sh = new SecurityHelper(password, salt, ctx);
    SecurityWrapper.wrap(sh);
    return sh;
  }
  public String getSalt( ) {
    return salt;
  }
  public static KeyParametersEnum getKeyParameters( ) {
    return DEFAULT;
  }
  public Store get( ) {
    return store;
  }
  public void save(Store store) {
    CipherOutputStream cos = null;
    try {
      Cipher cipher = Cipher.getInstance(ALGORITHM, PROVIDER);
      cipher.init(Cipher.ENCRYPT_MODE, key);
      FileOutputStream out =
ctx.openFileOutput(getKeyParameters( ).getStoreName( ), Context.MODE_PRIVATE);
      cos = new CipherOutputStream(out, cipher);
      store.writeTo(cos);
      cos.flush( );
      this.store = store;
    } catch (NoSuchAlgorithmException e) {
      logException(e);
    } catch (NoSuchPaddingException e) {
      logException(e);
    } catch (IOException ioe) {
      logException(ioe);
    } catch (InvalidKeyException e) {
      logException(e);
    } finally {
      AppHelper.close(cos);
    }
  }
  private Store getStore(Context ctx) {
    CipherInputStream cin = null;
    try {
      Cipher cipher = Cipher.getInstance(ALGORITHM, PROVIDER);
      cipher.init(Cipher.DECRYPT_MODE, key);
      cin = new
CipherInputStream(ctx.openFileInput(getKeyParameters( ).getStoreName( )),
cipher);
      store = Store.parseFrom(cin);
      return store;
    } catch (NoSuchPaddingException nspe) {
    } catch (IOException ioe) {
      Log.e(LogTypesEnum.IO.name( ), “Failed to read file”, ioe);
    } catch (NoSuchAlgorithmException nsae) {
      Log.e(LogTypesEnum.SECURITY.name( ), “No such security algorithm”,
nsae);
    } catch (InvalidKeyException ike) {
      Log.e(LogTypesEnum.SECURITY.name( ), “Invalid login attempt”, ike);
    } finally {
      AppHelper.close(cin);
    }
    return null;
  }
  public static long getTicks( ) {
    return getTicks(INTERVAL);
  }
  public static void wipe(Context ctx) {
    ctx.deleteFile(getKeyParameters( ).getStoreName( ));
  }
  public static long getTicks(int interval) {
    long current = Calendar.getInstance( ).getTimeInMillis( );
    return current / interval;
  }
  public String sign(String name, boolean simple, TransactionTypeEnum txn) {
    return sign(name, name, simple, txn);
  }
  public String sign(String name, String input, boolean simple,
TransactionTypeEnum txn) {
    Account account = mapAccount(name);
    byte[ ] ticks = Long.toString(getTicks( ) −
account.getOffset( )).getBytes( );
    ByteBuffer buffer = ByteBuffer.allocate(getKeyParameters( ).getLength( ) +
ticks.length + txn.getCode( ).length);
    buffer.put(account.getSkey( ).asReadOnlyByteBuffer( ));
    for (int i = 0; i < ticks.length; i++) {
      buffer.put(account.getIndex( ) + i, ticks[i]);
    }
    for (int i = 0; i < txn.getCode( ).length; i++) {
      buffer.put(account.getIndex( ) + ticks.length + i, txn.getCode( )[i]);
    }
/ ToDo add PIN to the hash /
    Mac mac = getKeyParameters( ).getMac( );
    SecretKey key = new SecretKeySpec(buffer.array( ), “RAW”);
    try {
      mac.init(key);
      if (simple) {
        return computeIntFromHash(mac.doFinal(input.getBytes( )));
      }
      return Base64.encodeBytes(mac.doFinal(input.getBytes( )));
    } catch (Exception e) {
      AssertionError ae = new AssertionError(“Unexpected exception”);
      ae.initCause(e);
      throw ae;
    }
  }
  private Account mapAccount(String name) {
    List<Account> accounts = store.getAccountList( );
    for (Account account : accounts) {
      if (name.equals(account.getId( ))) return account;
    }
    return null;
  }
  private String computeIntFromHash(byte[ ] hash) {
    int offset = hash[hash.length − 1] & 0xf;
    int binary =
      ((hash[offset] & 0x7f) << 24) | ((hash[offset + 1] & 0xff) << 16) |
      ((hash[offset + 2] & 0xff) << 8) | (hash[offset + 3] & 0xff);
    int otp = binary % DIGITS_POWER;
    StringBuilder result = new StringBuilder( ).append(otp);
    while (result.length( ) < TOKEN_SIZE) {
      result = result.append(“0”);
    }
    return result.toString( );
  }
  private static SecretKey generateKey(char[ ] password, byte[ ] salt) {
    SecretKeyFactory factory = getSecretKeyFactory( );
    PBEKeySpec spec = new PBEKeySpec(password, salt, ITER);
    try {
      return factory.generateSecret(spec);
    } catch (InvalidKeySpecException ivke) {
      Log.e(LogTypesEnum.SECURITY.name( ), “Failed to generate key”, ivke);
    }
    return null;
  }
  private static SecretKeyFactory getSecretKeyFactory( ) {
    try {
      return SecretKeyFactory.getInstance(ALGORITHM, PROVIDER);
    } catch (NoSuchAlgorithmException nsae) {
      Log.e(LogTypesEnum.SECURITY.name( ), “Failed to
load  security algorithm”, nsae);
    }
    return null;
  }
  public static void debug( ) {
    for (Service service : PROVIDER.getServices( )) {
      String algorithm = service.getAlgorithm( );
      if (algorithm.contains(“PBE”) || algorithm.contains(“AES”))
        Log.d(service.getType( ), algorithm);
    }
  }
  private static void logException(Throwable t) {
    Log.e(LogTypesEnum.SECURITY.name( ), “Unexpected security exception”, t);
  }
}
```

SetupActivity is a class for setting up accounts, in accordance with an embodiment:

```
package com.spignus.activities;
import android.os.Bundle;
import android.util.Log;
import android.view.View;
import com.google.protobuf.ByteString;
import com.spignus.constants.KeyParametersEnum;
import com.spignus.constants.LogTypesEnum;
import com.spignus.security.RandomHelper;
import com.spignus.security.SecurityHelper;
import com.spignus.storage.DeviceStorageHelper.Store;
/**
*
* @author Prasad Prasad
* (c) All Rights Reserved 2010
*
*/
public final class SetupActivity extends BaseActivity {
  private static final int PASSWORD_MIN_LENGTH = 6;
  @Override
  public void onCreate(Bundle bundle) {
    super.onCreate(bundle, R.id.saveSetupButton, R.layout.setup);
  }
  public void onClick(View v) {
    if (v.getId( ) == R.id.saveSetupButton) {
      String password =
validateAndGet(R.id.password1SetupET, R.id.password2SetupET,
PASSWORD_MIN_LENGTH);
      String salt = validateAndGet(R.id.pin1SetupET,
R.id.pin2SetupET, SALT_MIN_LENGTH);
      if (password == null || salt == null) {
        startActivity(createIntent(this, SetupErrorActivity.class));
      }
      RandomHelper randomHelper = RandomHelper.getInstance( );
      KeyParametersEnum keyParams =
      SecurityHelper.getKeyParameters( );
      SecurityHelper helper =
SecurityHelper.getSecurityHelper(password.toCharArray( ), salt, this);
      Store.Builder storeBuilder = Store.newBuilder( );
      storeBuilder.setLocal(ByteString.copyFrom(randomHelper.-
      getBytes(148)));
      storeBuilder.setIndex(randomHelper.-
      getInt(keyParams.getMaxIndex( )));
      storeBuilder.setOffset(randomHelper.getInt(Short.-
      MAX_VALUE));
      Store store = storeBuilder.build( );
      helper.save(store);
      Log.i(LogTypesEnum.VALIDATION.name( ), “INDEX: ” +
store.getIndex( ) + “ OFFSET: ” + store.getOffset( ));
      startActivityAndFinish(this, RegisterActivity.class);
    }
  }
}
```

SignaturesActivity is a class to display various signature that a user can perform on the device, in accordance with an embodiment:

```
package com.spignus.activities;
import java.util.ArrayList;
import java.util.List;
import android.app.AlertDialog;
import android.content.DialogInterface;
import android.os.Bundle;
import android.view.View;
import android.widget.ArrayAdapter;
import android.widget.Spinner;
import com.spignus.constants.TransactionTypeEnum;
import com.spignus.security.SecurityHelper;
import com.spignus.security.SecurityWrapper;
import com.spignus.storage.DeviceStorageHelper.Account;
import com.spignus.storage.DeviceStorageHelper.Store;
/**
*
* @author Prasad Prasad
* (c) All Rights Reserved 2010
*
*/
public class SignaturesActivity extends BaseActivity {
  @Override
  public void onCreate(Bundle bundle) {
    super.onCreate(bundle);
    refreshAndRegister( );
  }
  protected void refreshAndRegister( ) {
    setContentView(R.layout.signatures);
    listAccounts( );
    registerButton(R.id.websiteLoginBtn);
    registerButton(R.id.captchaBtn);
    registerButton(R.id.financialTxnBtn);
    registerButton(R.id.identifyMeBtn);
    changeViewVisibility(R.id.contractSignatureBtn,
        PreferencesActivity.CONTRACT_PREF, false);
    changeViewVisibility(R.id.conferenceCallBtn,
        PreferencesActivity.CONF_CALL_PREF, false);
  }
  protected void listAccounts( ) {
    Store store = SecurityWrapper.unwrap( ).get( );
    List<Account> storeAccountsAsList = store.getAccountList( );
    List<String> accountsAsList = new ArrayList<String>(
        storeAccountsAsList.size( ));
    for (Account account : storeAccountsAsList) {
      accountsAsList.add(account.getId( ));
    }
    String[ ] accounts = new String[accountsAsList.size( )];
    accountsAsList.toArray(accounts);
    ArrayAdapter<String> adapter = new ArrayAdapter<String>(this,
        android.R.layout.simple_spinner_item, accounts);
    adapter
.setDropDownViewResource(android.R.layout.-
simple_spinner_dropdown_item);
    Spinner spinner = (Spinner) findViewById(R.id.lmSpinner);
    spinner.setAdapter(adapter);
  }
  protected void generateSignature(String accountName,
  String value, TransactionTypeEnum txn) {
    SecurityHelper helper = SecurityWrapper.unwrap( );
    AlertDialog.Builder alertbox = new AlertDialog.Builder(this);
    alertbox.setMessage(helper.sign(accountName, value,
        !isEnabled(PreferencesActivity.SIGNATURE_PREF, false),
        txn));
    alertbox.setNeutralButton(R.string.dismissDialogBtn,
        new DialogInterface.OnClickListener( ) {
          public void onClick(DialogInterface d, int id) {
            d.dismiss( );
            refreshAndRegister( );
          }
        });
    alertbox.show( );
  }
  public void onClick(View view) {
    if (view.getId( ) == R.id.financialTxnBtn) {
      startActivity(createIntent(this, FinancialSignatureActivity.class));
      return;
    }
    TransactionTypeEnum txn;
    switch (view.getId( )) {
    case R.id.websiteLoginBtn:
      txn = TransactionTypeEnum.PASSWORD;
      break;
    case R.id.captchaBtn:
      txn = TransactionTypeEnum.CAPTCHA;
      break;
    case R.id.conferenceCallBtn:
      txn = TransactionTypeEnum.CONF_CALL;
      break;
    case R.id.contractSignatureBtn:
      txn = TransactionTypeEnum.CONTRACT;
      break;
    case R.id.identifyMeBtn:
      txn = TransactionTypeEnum.IDENTIFY_ME;
      break;
    default:
      throw new AssertionError(“Ouch can't understand this
id ” + view.getId( ));
    }
    Spinner spinner = (Spinner) findViewById(R.id.lmSpinner);
    String accountName = (String) spinner.getSelectedItem( );
    generateSignature(accountName, accountName, txn);
  }
}
```

What is claimed is:

1. A system for providing transaction-level security, such as for the purpose of authentication, authorization and non-repudiation of business-related and other transactions, comprising:
an interface that enables a user to establish a shared secret with an service provider such as identity provider (IdP) service;
wherein the shared secret key comprises a combination, encoding or manipulation of one or more of a random key generated by the user using a device, a secret pin and activation code that are setup between the IdP service and user and associated with a registered account for that user and/or client;
wherein the user can thereafter use the IdP service for providing transaction-level security, such as authentication, authorization and non-repudiation of business-related and other transactions;
wherein the client is used to generate a transaction signature that comprises a combination, encoding, or manipulation of one or more of the shared secret stored at the client device, the user's secret pin as entered by the user, a time based value, a transaction identifier such as username, account number, such as a message authentication code (MAC), and the user provides the transaction signature as part of a transaction, or to an application; and
wherein the service provider or an application provides the transaction signature with transaction identifier such as username, account number to the IdP to validate the transaction signature.

2. The system of claim 1, further comprising:
wherein the interface that enables a user to register a client with an identity provider (IdP) service is provided at one or more of a client device, such as a mobile phone, personal digital assistant (PDA), netbook, or other computing device used to generate the random key, and wherein the user selects the secret pin which is not stored on the device, but is entered by the user when needed;
wherein upon the IdP service receiving the random key and the secret pin as provided to the IdP service and associated with the registered account for that user and/or client, the IdP service then optionally generates an activation code which is combined with the random key to create the shared secret, and the activation code is communicated back to the client device over a different communication medium, where the client device uses the activation code to compute the shared secret; and
wherein, when the user provides the transaction signature as part of a transaction, or to an application, the transaction or application receiving the transaction signature can use the IdP service to validate the transaction and/or authenticate or otherwise verify the user and/or the client.

3. The system of claim 1, wherein the system is used to provide one or more of
a user captcha feature,
a notary-like function,
a building entrance security feature, or
a method for validating a remote computer operation for lifecycle services such as starting, stopping, and restarting system after validating operation signature.

4. The system of claim 1, wherein the system is used to provide one or more of a simple authentication with an IdP service provider or a consumer using the service, or for mutual authentication between two entities.

5. The system of claim 1, wherein the system is used in verifying online and/or in-person credit-card transactions.

6. The system of claim 1, wherein the system is used in providing authenticated communications, such as conference calls.

7. The system of claim 1, wherein the system is used in providing verified and/or non-repudiatable contract signings, and/or to authenticate a user's agreement to a contract, terms, conditions, or other agreement.

8. The system of claim 1, wherein multiple transaction sites and/or multiple applications can share a common IdP to provide verification or authentication of the user and/or the client device for transactions that may span the multiple transaction sites and/or applications.

9. The system of claim 1, wherein multiple accounts and/or multiple applications can be maintained on a single client device, and when multiple accounts are used, each account on the client device is optionally based on its own unique shared secret, and generation of individual account keys is optionally based on a master key.

10. The system of claim 1, wherein the system enables validating a transaction and/or authentication or otherwise verification of the user and/or the client, without exchange of secrets with the service provider, and/or without requiring the user to provide personally-identifiable information such as SSN, date of birth to get customer service from a service provider.

11. The system of claim 1, wherein as an alternative to the user themselves registering the client device, an already preconfigured client device can be provided to the user, eliminating the steps required for establishing shared secrets.

12. The system of claim 1, wherein the signature is provided in a machine or computer-readable format, near field communication, or other format.

13. The system of claim 1, wherein the system includes provisioning of a delegated IdP.

14. The system of claim 1, wherein the system uses time-varying encryption key generation for communication between two entities. This time-varying key can be replacing session and serving the dual purpose of authentication and giving same capabilities to a stateless protocol as stateful protocol.

15. The system of claim 1, wherein the system enables push/pull of encrypted use and/or other data between a client device and a server for use in provisioning and data recovery purposes.

16. The system of claim 1, wherein the single use transaction signature can include identifiable addressing information about a client and/or server such as IP addresses, DNS name for use during authentication and authorization.

17. The system of claim 1, wherein the same transaction signature is prevented from being used for different purposes.

18. The system of claim 1, wherein, after a particular number of retry attempts, the device or user account is disabled, to protecting the user from potential fraud or malicious behavior.

19. A method for providing transaction-level security for the purpose of authentication, authorization and non-repudiation of business-related and other transactions, comprising the steps of:
providing an interface that enables a user to establish a shared secret with an service provider such as identity provider (IdP) service, wherein the shared secret key comprises a combination, encoding or manipulation of one or more of a random key generated by the user using a device, a secret pin and activation code that are provided to the IdP service and associated with a registered account for that user and/or client;
wherein the user can thereafter use the IdP service for providing transaction-level security, such as authentication, authorization and non-repudiation of business-related and other transactions;
wherein the client is used to generate a transaction signature that comprises a combination, encoding, or manipulation of one or more of the shared secret stored at the client device, the user's secret pin as entered by the user, a time based value, a transaction identifier such as username, account number, such as a message authentication code (MAC), and the user provides the transaction signature as part of a transaction, or to an application; and
wherein the service provider or an application provides the transaction signature with transaction identifier such as username, account number to the IdP to validate the transaction signature.

20. The method of claim 19, further comprising:
wherein the interface that enables a user to register a client with an identity provider (IdP) service is provided at one or more of a client device, such as a mobile phone, personal digital assistant (PDA), netbook, or other computing device used to generate the random key, and wherein the user selects the secret pin which is not stored on the device, but is entered by the user when needed;
wherein upon the IdP service receiving the random key and the secret pin as provided to the IdP service and associated with the registered account for that user and/or client, the IdP service then optionally generates an activation code which is combined with the random key to create the shared secret, and the activation code is communicated back to the client device preferably over a different communication medium, where the client device uses the activation code to compute the shared secret; and
wherein, when the user provides the transaction signature as part of a transaction, or to an application, the transaction or application receiving the transaction signature can use the IdP service to validate the transaction and/or authenticate or otherwise verify the user and/or the client.

21. The method claim 19, wherein the system enables validating a transaction and/or authentication or otherwise verification of the user and/or the client, without exchange of secrets with the service provider, and/or without requiring the user to provide personally-identifiable information.

22. A non-transitory computer readable storage medium including instructions stored thereon which, when executed by a computer, cause the computer to perform the steps of:
providing an interface that enables a user to establish a shared secret with an service provider such as identity provider (IdP) service, wherein the shared secret key comprises a combination, encoding or manipulation of one or more of a random key generated by the user using a device, a secret pin and activation code that are setup between the IdP service and user and associated with a registered account for that user and/or client;
wherein the user can thereafter use the IdP service for providing transaction-level security, such as authentication, authorization and non-repudiation of business-related and other transactions;
wherein the client is used to generate a transaction signature that comprises a combination, encoding, or manipulation of one or more of the shared secret stored at the client device, the user's secret pin as entered by the user, a time based value, a transaction identifier such as username, account number, such as a message authentication code (MAC), and the user provides the transaction signature as part of a transaction, or to an application; and
wherein the service provider or an application provides the transaction signature with transaction identifier such as username, account number to the IdP to validate the transaction signature.
